(19) United States
(12) Patent Application Publication
(10) Pub. No.: US 2002/0087982 A1
(43) Pub. Date: Jul. 4, 2002

(54) Electronic program guide with rapid time advancement feature

(76) Inventor: Anthony Edward Stuart, Indianapolis, IN (US)

Correspondence Address: Joseph S. Tripoli, THOMSON multimedia Licensing Inc., Patent Operations, Two Independence Way, P.O. Box 5312, Princeton, NJ, 08543-5312, US

(21) Appl. No.: 09/752,700

(22) Filed: Dec. 29, 2000

(51) Int. Cl. H04N 5/445

(52) U.S. Cl. 725/39; 725/42; 725/43

(57) ABSTRACT

Method and apparatus for rapidly advancing an EPG, wherein a viewer can use a time line to advance an EPG hours, days, weeks and/or months in the future to a desired day and time. The viewer can then advance the time window of the EPG as is conventionally done in one-half hour increments to view desired program listings.

### FIELD OF THE INVENTION

This invention relates to electronic program guides (EPGs), and more particularly to an EPG that can be rapidly moved forward or backwards in time.

### BACKGROUND OF THE INVENTION

An EPG is an interactive, on-screen display feature that displays information analogous to TV listings found in local newspapers or other print media. In addition, an EPG also includes information necessary for collating and decoding programs. An EPG provides information about each program within the time frames covered by the EPG, which typically ranges from the most previous half-hour up through the next seven days. The information contained in an EPG may include programming characteristics such as channel number, program title, start time, end time, elapsed time, time remaining, rating (if applicable), topic, theme, and a brief description of the program's content. EPGs are usually arranged in a two-dimensional table or grid format with time on one axis and channel numbers on the other axis.

Unlike non-interactive guides that reside on a dedicated channel and merely scroll through the current programming on the other channels for the next 2 to 3 hours, EPGs allow viewers to obtain and view programming information in a variety of formats including current channel, partial list of channels, and all channels. Further, EPG features may include the ability to highlight individual cells of the grid containing program information. Once highlighted, the viewer can perform functions pertaining to the selected program. For example, the viewer could instantly switch to that program if it is currently being aired. Viewers could also program one touch video cassette recording (VCR) or the like if the television is properly configured and connected to a recording device.

Conventional EPG's suffer from a significant drawback. Specifically, to such devices can only be moved forward and backward in time in short time intervals, e, g., one-half hour intervals. Therefore, to view program listings, for example, for programs to be shown several days later than that currently being displayed requires that the EPG be tediously and slowly advanced in half-hour increments by repeatedly pressing on a navigation key on a remote control device many times. It is therefore an object of the present invention to provide an EPG that overcomes this drawback.

### SUMMARY

An EPG that allows a viewer to rapidly move a program guide time line forward or backward in time in any desired time increment whether said time increment be hours, days, weeks or months. Once the desired day and time have been displayed on a display device, the program guide time line can be advanced in half hour increments as in conventional devices.

### BRIEF DESCRIPTION OF THE DRAWINGS

FIG. 1 shows a block diagram of a multi-media system including an EPG, the system processing both analog NTSC (PAL or other scheme) television signals, and Internet information.

FIG. 2 shows a system hardware block diagram of a simplified EPG implementing system that may utilize the present invention.

FIG. 3 shows a conventional EPG for a given time of a given day.

FIG. 4 shows an EPG according to the present invention for the same time and day as that shown in FIG. 3

FIG. 5 shows the EPG according to the present invention for the same time of day as that shown in FIGS. 3 and 4 but on a different day.

### DETAILED DESCRIPTION OF THE INVENTION

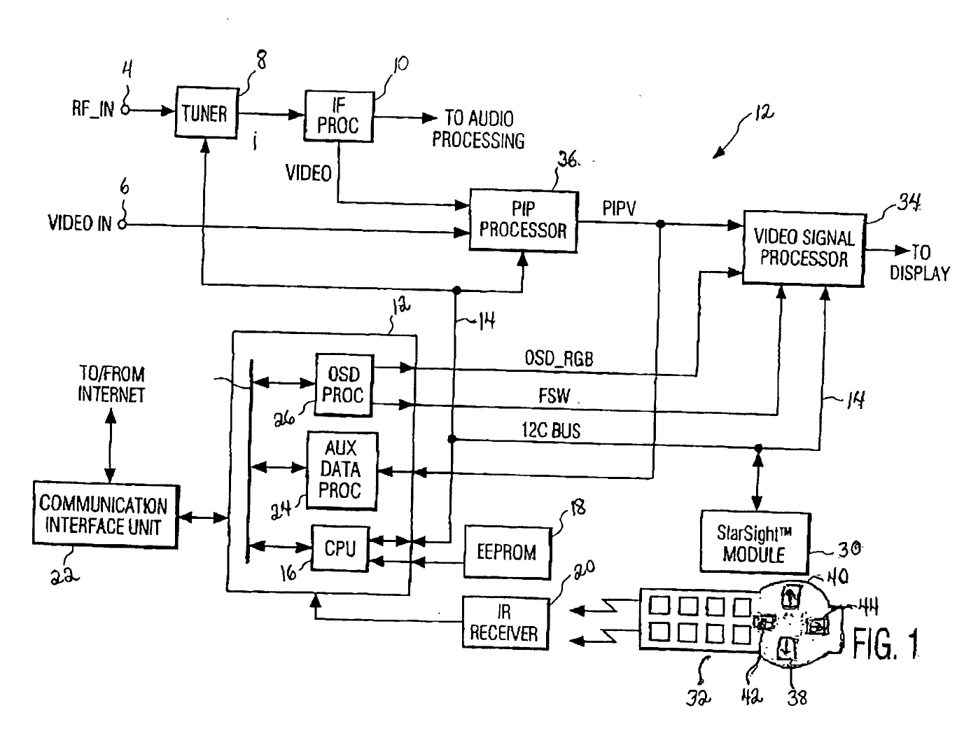

One example of a television system suitable for providing a user interface such that referred to above is a television receiver for processing both analog NTSC television signals and Internet information such as shown in FIG. 1. This system has a first input 4 for receiving radio RF television signals from a source such as an antenna or a cable system and a second input 6 for receiving baseband television signals from, for example, a VCR or DVD player. As is well known in the art, tuner 8 and IF processor 10 operates in a conventional manner for tuning and demodulating a particular television signal at RF_IN input 4. Although FIG. 1 shows input 6 as a baseband signal, the television receiver could include a second tuner and IF processor for producing a second baseband video signal from either signal RF_IN or from a second RF signal source. Multiple signal inputs of all kinds may be provided for processing.

Microprocessor (μP) 12 controls the system by sending and receiving both commands and data via serial data bus I²C BUS 14 which utilizes the well-known I²C serial data bus protocol (or other possible protocol e.g. 1394). Further, as is well known in the art, μP 12 contains central processing unit (CPU) 16 which is coupled to an external memory device, such as EEPROM 18 and is responsive to commands provided by a user, e.g. via IR (Infra Red) receiver 20. Of course, other bus protocols and/or structures may also be utilized. (μP) 12 also controls the operation of a communication interface unit 22 for providing the capability to download and upload information from the Internet, for example. Communication interface unit 22 includes, for example, a modem for connecting to an Internet service provider, e.g. via a telephone line or via cable television line. The communications interface unit 22 provides communication capability and Internet related features such as web browsing in addition to receiving television programming.

CPU 16 controls well known functions (such as auxiliary data processor 24 and OSD processor 26) included within μP 12 via bus 28. Auxiliary data processor 24 extracts auxiliary data such as programs, for example, from StarSight™ module 30. StarSight™ data comprises EPG information for a number of days as described above along with various Internet related information including Internet links. A processor internal to StarSight™ module 30 formats and stores the data in memory within itself. In response to the StarSight™ EPG display being activated (e.g., a user activating a particular key on remote control 32), CPU 1112 transfers formatted StarSight™ EPG display data from StarSight™ module 34 via 1²C BUS to OSD processor 26. OSD processor 26 operates in a conventional manner such that when coupled to a display device, it will produce a displayed image representing on-screen display information such as graphics and/or text comprising an EPG. OSD processor 26 also produces control signal FSW which is intended to control a fast switch for inserting signals OSD_RGB into the system's video output signal at times when an on-screen display is to be displayed.

Video Signal Processor (VSP) 34 performs conventional video signal processing functions, such as luma and chroma processing. Output signals produced by VSP 34 are suitable for coupling to a display device, e.g., a kinescope or LCD device (not shown in FIG. 1), for producing a displayed image. VSP 34 also includes a fast switch for coupling signals produced by OSD processor 26 to the output video signal path at times when graphics and/or text is to be included in the displayed image. The fast switch is controlled by control signal FSW that is generated by OSD processor 26 in main μP 12 at times when text and/or graphics are to be displayed. The input signal for VSP 34 is signal PIPV that is output by picture-by-picture (PIP) processor 36.

For an EPG display, the display data included in the EPG display is produced by OSD processor 26 and included in the output signal by VSP 34 in response to fast switch signal FSW. When μP 12 detects activation of the EPG display, e.g., when a user presses the appropriate key on remote control 32, μP 12 causes OSD processor 26 to produce the EPG display using information such as program guide data from StarSight™ module 30. Microprocessor 12 causes VSP 34 to combine the EPG display data from OSD processor 26 and the video image signal in response to signal FSW to produce a display including EPG. The EPG can occupy all or only a portion of the display area.

When the EPG display is active, μP 12 executes a control program stored in EEPROM 18. The control program monitors the location of a position indicator, such as a highlight and/or highlighting, in the EPG display. A user controls the location of the position indicator using, for example, direction and selection keys of remote control 32. Alternatively, the system could include a mouse device. Microprocessor 12 detects activation of a selection device, such as clicking a mouse button, and evaluates current highlight location information in conjunction with EPG data being displayed to determine the function desired, e.g., tuning a particular program. Microprocessor 12 subsequently activates the control action associated with the selected feature.

Another example of an electronic device implementing a user interface system is a system for processing digital video and audio signals such as an MPEG compatible system for receiving MPEG encoded transport streams representing broadcast programs. User interface systems are also applicable to other types of digital signal processing devices including non-MPEG compatible systems, involving other types of encoded data streams. For example, other devices include digital video disc (DVD) systems, digital video computer and television functions such as so-called “PCTV”, and High Definition Television (HDTV) receiver.

The remote control 32 is provided with keys 38 and 40 that respectively move a time window forward and backward in time and keys 42 and 44 that respectively scroll the positions for the channels up and down.

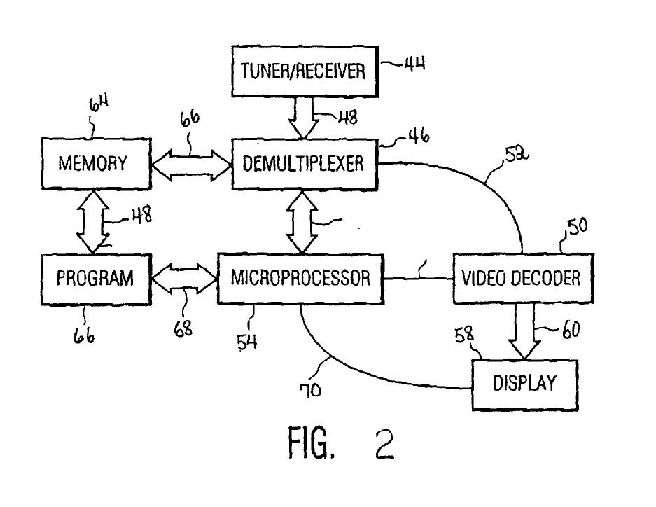

Referring now to FIG. 2, there is shown a simplified system hardware block diagram delineating a configuration of a system that can generate EPG's, especially EPGs with the various functions and capabilities and in accordance with the principles of the present invention as indicated herein. Tuner/Receiver 44 receives input audio and/or video signals from a variety of sources, both terrestrial and satellite in known ways, and provides the same demultiplexer 46 via communication/data bus 48. Demultiplexer 46 demultiplexes the incoming signals from the tuner/receiver 44 and sends the video portion containing the video of the chosen program of the incoming signal to video decoder 50 via communication/data bus/line 52. Video decoder 50 under direction from microprocessor 54 via communication/data line 56 provides the decoded signals to display 58 via communication/data line 60. Demultiplexer 46 is in communication with microprocessor 54 via communication/data line 62 for control of video decoder 58.

Demultiplexer 46 also stores in memory 64 via communication/data line 66 another portion of the demultiplexed incoming signal relating to EPG data under direction of microprocessor 54. The EPG data is stored in memory 64 until such data is needed. Microprocessor 54 is under direction the of stored program 66 via communication/data line 68. EPG data stored in memory 64 is provided to video decoder 50 for showing on display 58 when display 58 is in an EPG display mode. Display 58 is also in communication with microprocessor 54 via communication/data line 70.

In one embodiment, tuner/receiver 44 tunes to the channel broadcasting StarSight™ (EPG) data during a particular time dependent upon program 66. During data reception, demultiplexer 46 stores the EPG data in memory 64. During viewing, demultiplexer 46 provides video information to video decoder 50 and display 58 upon activation, EPG data including the present graphical representation of current time from memory 64 is displayed on display 58.

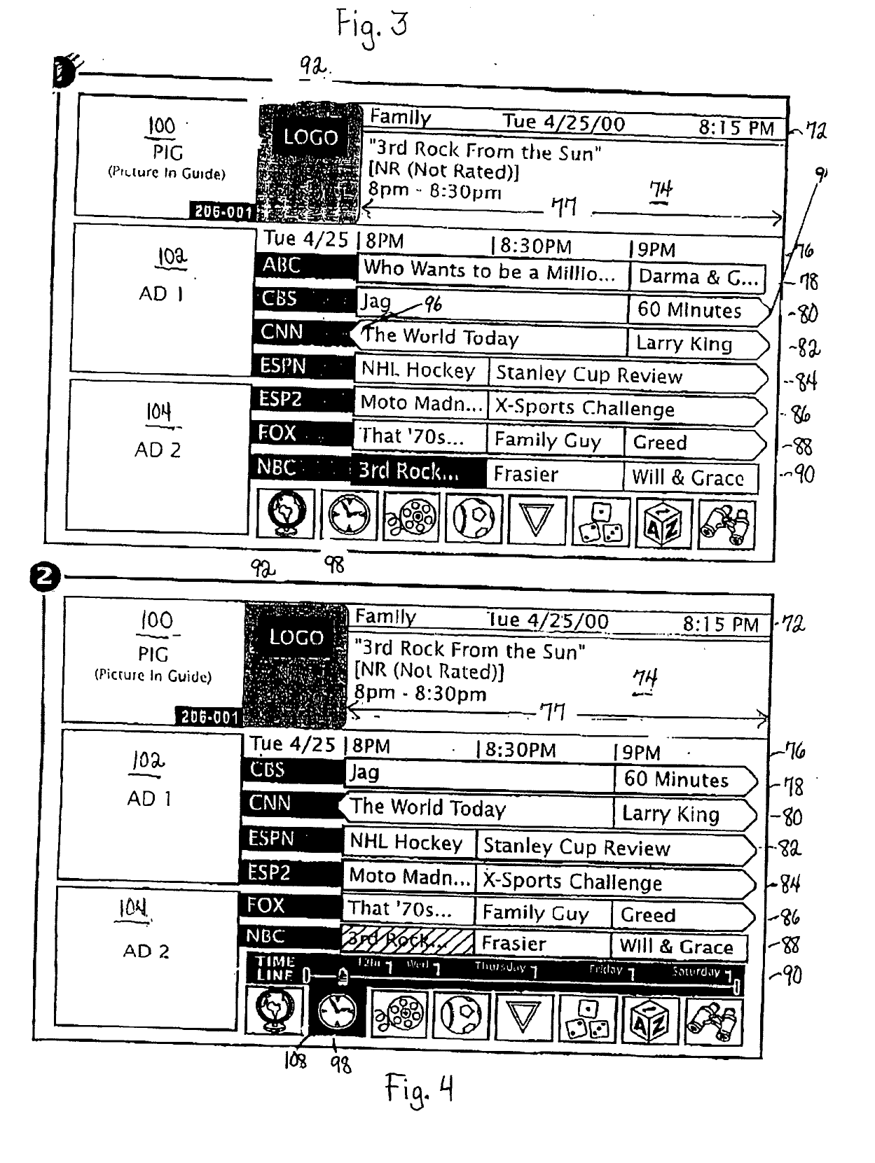

Reference is now made to FIG. 3 showing a conventional EPG whose features are included in the EPG of the present invention. A top line 72 displays the current day, date and time, shown herein as being Tuesday, Apr. 25, 2000, and 8:15 p.m., respectively. Just below line 72, a space 74 displays the full title, program rating, and time a show is broadcast, shown herein as being “3^{rd} Rock From The Sun”, “Not Rated”, and from 8 p.m. and 8:30 p.m., respectively.

Below space 74 is a line 76 containing the day, date and a time window 77 which in this example extends between 8 p.m. and 9:30 p.m. wherein this one and one-half hour time period is divided into one-half hour intervals. As shown in line 72, the current time is 8:15 p.m., the intervals are 8 p.m. to 8:30 p.m., 8:30 p.m. to 9 p.m. and 9 p.m. to 9:30 p.m., with this last time, i.e., 9:30 p.m., not being shown. Although, time window 77 shown in this example is for a time period of one and one-half hours, it can be for shorter or longer periods of time.

In lines 78 through 90, listings for channels/networks are displayed in a column 92 below the day and date shown on line 76. To the right of each channel/network listing is displayed the program titles and/or other program indicia of the programs broadcast during the aforementioned time intervals. For example, the listing for ABC shows “Who Wants To Be A Millio” being broadcast between 8 p.m. and 9 p.m. and “Darma & G” being broadcast between 9 p.m. and 9:30 p.m. An arrowhead is used to indicate when a program extends beyond the time window displayed on the display device. For example, an arrowhead 94 indicates that the CBS program “60 Minutes” extends beyond 9:30 p.m., and an arrowhead 96 indicates that the CNN program “The World Today” started before 8 p.m. The program presently of interest but not necessarily being viewed is NBC's “3^{rd} Rock” as shown by the highlighting.

Underneath bottom line 90 is a row of icons, such as clock icon 98, which can be selected using remote control to select respective operations. Spaces 100, 102 and 104 appear to the left of column 92 are displaying the program currently being viewed by a viewer and advertisements AD1 and AD2, respectively.

The conventional EPG shown in FIG. 3 is typically displayed on a display device by pressing a button on remote control device 32. Using the navigation buttons on remote control 32, a user can move time window 77 forward and backward in time in successive one half-hour intervals. Whereas this method of operation is satisfactory for viewing program listings occurring only a few hours before or after the current displayed time, it becomes tedious if the viewer wishes to view program listings occurring more than a few hours earlier or later in time because of the number of times the navigation buttons on remote control 32 must be pressed to move time window 77.

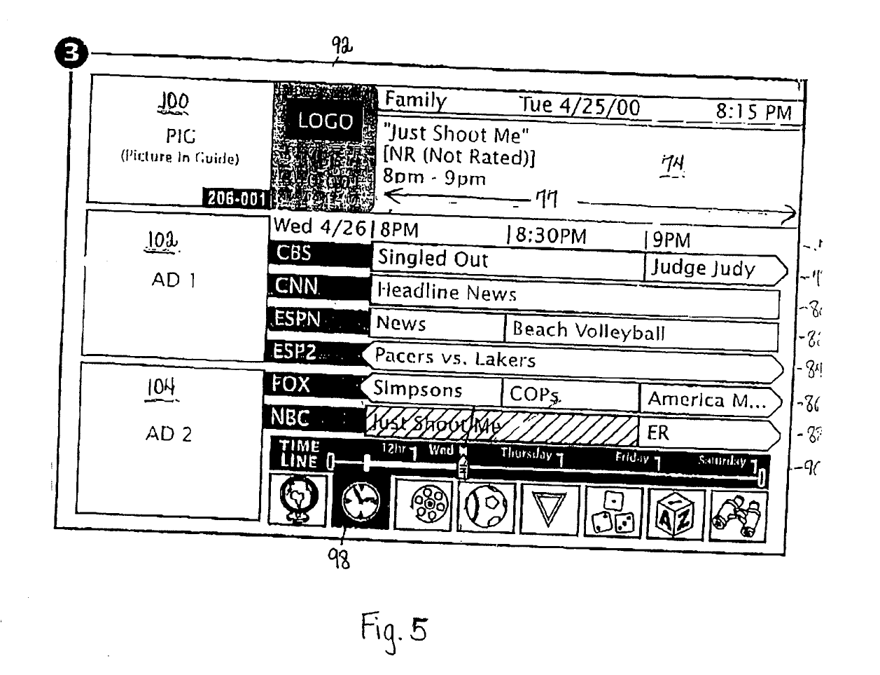

To overcome this problem, the advantageous operation provided by the EPG of the present invention may be attained by using remote control 32 to highlight, i.e., select, the clock icon 98 on FIG. 3 and bring up the display shown in FIG. 4. When clock icon 98 is selected, a time line 106 appears in place of bottom line 90 that was previously occupied by NBC and its program listings in FIG. 3. Also, the channel/network and program listings of lines 78 through 90 shown in FIG. 3 are moved up one line so that the listing for ABC and its programs disappear. If a viewer desires to view the program listings for ABC, as well as for channels/networks other than those shown in lines 7890, the viewer need only use remote control 32 to scroll downward or upward. In both FIGS. 3 and 4, the viewer is shown by way of example to have been interested in the program “3^{rd} Rock” as indicated by primary and secondary highlighting, respectively.

If the viewer wishes to remove time line 106 from the screen, the viewer need only use the remote control to highlight clock icon 98. This will result in another channel/network and its program listings being displayed in place of time line 106. In an alternative embodiment of the present invention, a viewer would not have to select clock icon 98 from the EPG shown in FIG. 3 in order to make time line 106 appear. Rather, time line 106 could always be displayed on a display device as part of the EPG.

Time line 106 includes a slidable marker 108 shown at 8 p.m. that can be slid forward, and backward, along the time line 106 using remote control 32. Time line 106 also includes notches delineating times/days in the future to which marker 108 can be slid. As shown in FIG. 4, these notches are indicated at 12 hrs, Wednesday, Thursday, Friday and Saturday. However, time line 106 can include notches that delineate a times/days any number of hours, days, weeks and/or even months in the future. Time line 106 could also include notches that delineate times in the past if a viewer wanted to view program listings for programs that were already broadcast.

Time line 106 is used as follows. If a viewer of the EPG shown in FIG. 4, which shows some of Tuesday's program listings, wishes to review program listings for the next day, the viewer can use remote control 32 to move marker 108 to the notch marked Wednesday, thereby bringing up on the display device the program listings shown in FIG. 5 that start at 8 p.m. on Wednesday. Note that the day in line 76 of FIG. 5 is now Wednesday, the date is now 4/26, and that the highlighted program “Just Shoot Me” appears in place of and in the same position as “3^{rd} Rock” which previously appeared in FIGS. 3 and 4. Thus, a viewer can use time line 106 to rapidly advance the EPG many hours, days, etc., in the future to a desired day and time. The viewer can then advance time window 76 of the EPG as is conventionally done in one-half hour increments to view program listings of interest.

The present invention can be used in satellite television systems; ground based television broadcast systems, both digital and analog; a settop box receiver; a wireless telephone; a wireless personal assistant such as a Palm Pilot®; or on any type of wired or wireless device that enables digitally stored information to be viewed on a display device. Also, information displayed and viewed using the present invention can be printed, stored to other storage medium, and electronically mailed to third parties.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

What is claimed is:

1. A method for rapidly advancing an electronic program guide, comprising the steps of:
displaying on a display device a time line having notches thereon delineating times and days in the future from a current day and time to which a marker can be slidably moved;
slidably moving the marker to a notch delineating a desired day and time in the future, thereby causing to be displayed in a time window displayed on the display device a time period displaying indicia for programs to be broadcast during the time period on said desired day and time.

2. The method according to claim 1, wherein the notches delineate times that are hours, days, weeks and months in the future from the current day and time.

3. The method according to claim 1, further comprising the step of moving the time window to view desired program indicia.

4. The method according to claim 3, further comprising the step of moving the time window in one-half hour increments.

5. The method according to claim 1, wherein the marker can be selectively moved forward and backward in time.

6. The method according to claim 1, wherein the marker can be selectively moved backwards in time to display indicia for programs that were already broadcast.

7. The method according to claim 1, wherein the method is implemented using a remote control device.

8. A method for rapidly advancing an electronic program guide, comprising the steps of:
displaying on a display device a time line having notches thereon delineating times and days in the future from a current day and time to which a marker can be slidably moved;
displaying on the display device a time window defining a first time period on the current day, wherein the time window displays indicia for programs broadcast during the first time period of the current day; and
slidably moving the marker to a notch delineating a desired day and time in the future, thereby causing to be displayed in the time window a second time period displaying indicia for programs to be broadcast during the second time period on said desired day and time.

9. The method according to claim 8, wherein the second time period is for a period of time on a different day than the first time period

10. The method according to claim 8, wherein the second time period overlaps the first time period.

11. The method according to claim 8, wherein the first and second time periods are successive time periods.

12. An apparatus for rapidly advancing an electronic program guide, comprising:
a display device displaying a time line having notches thereon delineating times and days in the future from a current day and time; and
a slidable marker which can be slid to a notch delineating a desired day and time in the future, thereby causing to be displayed in a time window displayed on the display device a time period displaying indicia for programs to be broadcast during the time period on said desired day and time.

13. The apparatus according to claim 12, wherein the notches delineate times that are hours, days, weeks and months in the future from the current day and time.

14. The apparatus according to claim 12, wherein the time window can be moved in one-half hour increments.

15. The apparatus according to claim 12, wherein the marker can be selectively moved forward and backward in time.

16. The apparatus according to claim 12, wherein the marker can be selectively moved backwards in time to display indicia for programs that were already broadcast.

17. The apparatus according to claim 12, wherein the apparatus is operated using a remote control device.

18. An apparatus for rapidly advancing an electronic program guide, comprising:
a display device displaying a time line having notches thereon delineating times and days in the future from a current day and time to which a marker can be slidably moved, and also displaying a time window defining a first time period on the current day, wherein the time window displays indicia for programs broadcast during the first time period of the current day; and
a slidable marker which can be slid to a notch delineating a desired day and time in the future, thereby causing to be displayed in the time window a second time period displaying indicia for programs to be broadcast during the second time period on said desired day and time.

19. The apparatus according to claim 18, wherein the second time period is for a period of time on a different day than the first time period

20. The apparatus according to claim 18, wherein the second time period overlaps the first time period.

21. The apparatus according to claim 18, wherein the first and second time periods are successive time periods.
